(19) United States
(12) Patent Application Publication
(10) Pub. No.: US 2022/0079264 A1
(43) Pub. Date: Mar. 17, 2022

(54) Handheld Mask Assembly

(71) Applicant: Brent Bradford, Beaumont, TX (US)

(72) Inventor: Brent Bradford, Beaumont, TX (US)

(21) Appl. No.: 17/142,563

(22) Filed: Jan. 6, 2021

Related U.S. Application Data
(60) Provisional application No. 63/077,741, filed on Sep. 14, 2020.

(51) Int. Cl. A41D 13/11

(52) U.S. Cl. CPC A41D 13/1138; A41D 2400/44

(57) ABSTRACT

A handheld mask assembly for protecting a user's face without a strap. The handheld mask assembly comprises a face mask component, an attachment component, and a rod. The attachment component is joined to or otherwise integrated into a corner of the facemask component and is configured to engage one end of the rod. One end of the rod is insertable into the attachment component when the user desired to hold the face mask component over their nose and mouth. The rod is removable when not needed. The handheld mask assembly may further comprise a strap for engaging the face mask component to secure the face mask component around the user's head for longer periods of time when the rod is removed.

### CROSS-REFERENCE TO RELATED APPLICATION

The present application claims priority to, and the benefit of, U.S. Provisional Application No. 63/077,741, which was filed on Sep. 14, 2020 and is incorporated herein by reference in its entirety.

### BACKGROUND

The present invention generally relates to a face mask and rod assembly, and more specifically to a handheld face mask that is attachable to a handle. Accordingly, the present specification makes specific reference thereto. However, it is to be appreciated that aspects of the present invention are also equally amenable to other like applications, devices and methods of manufacture.

Germs, viruses, bacteria, microbes, and other airborne pathogens are incredibly dangerous and can cause serious illness or death. Without proper personal protective equipment, such as face masks, people are increasingly susceptible to inhaling these harmful airborne pathogens. Protective face masks typically cover the mouth and nose leaving the user with no way to consume food or beverages unless they completely remove the mask from their face. Fully removing the mask in public spaces can put the user at greater risk of infection. Not wearing a mask at all in public puts the user at risk of not complying with public health laws or recommendations. This can lead to removal from a restaurant or other venue in addition to potential legal ramifications.

Germs, viruses, bacteria, microbes, and other pathogens are microscopic living things persisting everywhere in nature and are often airborne. A pathogen is a micro-organism that has the potential to cause disease. Introducing these pathogens and organisms into the body by inhalation or through the mucus membranes can lead to serious illness or even death. Poor personal hygiene or the lack of proper personal protective equipment puts people at greater risk of infection as they come into contact with these organisms especially in indoor environments or when people are in close proximity.

Viruses are a common cause of infectious diseases that have a considerable impact on an individual's health. Transmission or a virus typically occurs directly from person to person, often by inhalation. COVID-19 is a virus caused by a coronavirus called SARS-CoV-2. It spreads mainly through respiratory droplets produced when an infected person coughs or sneezes. These droplets can land in the unprotected mouths or noses of people who are nearby or possibly be inhaled into the lungs. Spread of the virus is more likely when people are in close contact with one another without any protective barrier in place. Face masks are the primary physical barrier typically used to decrease or prevent this type of airborne virus transmission. Additionally, many countries and governments either recommend or even mandate the use of some kind of face mask barrier in public spaces during public health emergencies such as a pandemic or other healthcare crisis.

Face masks have been used in the health care industry and even in public places to limit or prevent the transmission of disease for years. Health experts consistently agree that masks prevent or at least limit the spread of disease. Masks are typically beneficial as they can protect the wearer from exposure to air born transmission of disease, contaminates, and pollutants. Masks used by an infected individual protect others as masks contain much of the exhaled and expelled airborne respiratory droplets from the infected person.

One problem with convincing people to wear masks is the uncomfortable nature of masks and how they may affect breathing. Standard masks limit restrict airflow inherent in applying a physical barrier over the mouth and nose. Additionally, when strapped around a person's head for an extended period of time, they can make the user anxious and feel claustrophobic. A mask that is strapped in place also limits one's ability to feel like they are in control of the situation. Mask straps can rub against sensitive skin areas causing abrasions and skin irritation.

In this manner, the improved handheld mask of the present invention accomplishes all of the forgoing objectives, thereby providing an easy solution to protect a user from airborne contaminants and pathogens. A primary feature of the present invention is the ability to hold a mask barrier against the face without a strap allowing the user flexibility to protect themselves when necessary. Further, the improved handheld mask assembly of the present invention is capable of allowing individuals to comply with healthcare or public health requirements as necessary without always having to keep the mask in place.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a handheld mask assembly. The handheld mask assembly comprises a face mask component. The face mask component may be rigidly constructed or may be moldable and is shaped to cover a user's nose and mouth. The face mask component comprises a perimeter, an apex, a base, and a pair of sides. The apex is configured to encapsulate the nose and the base is configured to fit the user's chin. The face mask component may further comprise a cushion element. The cushion element may be a gasket or flexible pad that surrounds the perimeter and is attached or adhered to an interior surface of the face mask component.

The handheld mask assembly further comprises an attachment component and a rod. The attachment component is connected to the face mask component. The attachment component may be molded into or integrated into a lower corner of the face mask component at an intersection between one of the pair of sides and the base. Alternatively, the attachment component may be connected to the face mask component anywhere else along the perimeter of the face mask component. The attachment component comprises a receiving element. The receiving element may be a hole for frictionally engaging one end of the rod. Alternatively, the receiving element may be a threaded hole. The attachment component may further comprise a rod attachment element. The rod attachment element may be a metallic or magnetic piece positioned within the receiving element.

The rod is generally tubular in configuration and comprises an attachment component end and a distal end. The rod may further comprise a handle encapsulating the distal end. The attachment component end comprises a connecting element. The connecting element is insertable into and engages the receiving element of the attachment component. The connecting element may engage the receiving element via friction. Alternatively, the connecting element may be a male threaded connector for screwing into the receiving element. Alternatively, the connecting element may be a magnet or piece of metal to engage the rod attachment element of the receiving element. The rod may further comprise a plurality of telescoping sections.

In an additional embodiment, the handheld mask assembly comprises a face mask component. The face mask component may be rigidly constructed or moldable and is shaped to cover a user's nose and mouth. The face mask component comprises a perimeter, an apex, a base, and a pair of sides. The apex is configured to encapsulate the nose and the base is configured to fit the user's chin. The face mask component may further comprise a cushion element. The cushion element may be a gasket or flexible pad that surrounds the perimeter and is attached or adhered to an interior surface of the face mask component. The face mask component may further comprise a pair of strap holes. The pair of strap holes penetrate the face mask component along the respective pair of sides adjacent to the perimeter.

The handheld mask assembly further comprises an attachment component and a rod. The attachment component is connected to the face mask component. The attachment component may be molded into or integrated into a lower corner of the face mask component at an intersection between one of the pair of sides and the base. Alternatively, the attachment component may be connected anywhere else along the perimeter of the face mask component. The attachment component comprises a receiving element. The receiving element may be a hole for frictionally engaging the rod. Alternatively, the receiving element may be a threaded hole. The attachment component may further comprise a rod attachment element. The rod attachment element may be a metallic or magnetic piece positioned within the receiving element.

The rod is generally tubular in configuration and comprises an attachment component end and a distal end. The rod may further comprise a handle encapsulating the distal end. The attachment component end comprises a connecting element. The connecting element is insertable into and engages the receiving element of the attachment component. The connecting element may engage the receiving element via friction. Alternatively, the connecting element may be a male threaded connector for screwing into the receiving element. Alternatively, the connecting element may be a magnet or piece of metal to engage the rod attachment element of the receiving element. The rod may further comprise a plurality of telescoping sections.

The handheld mask assembly further comprises a strap. The strap is a band of typically elastic or rubber material that can expand and contract to fit around the user's head to hold the face mask component securely against the user's face. The strap comprises a pair of flexible connecting elements insertable into the pair of strap holes of the face mask component. The strap is insertable into the strap holes for applications where the face mask component may be needed to be in place for an extended period of time. The rod is removable from the attachment component when the strap is in use. The strap is removable when no longer needed and the rod may be reinserted into the attachment component.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a handheld mask assembly of the present invention being positioned against a user's face in accordance with the disclosed architecture.

FIG. 2 illustrates a perspective view of the handheld mask assembly of the present invention in accordance with the disclosed architecture.

FIG. 3 illustrates a perspective view of the handheld mask assembly of the present invention with a rod detached from an attachment component of the handheld mask assembly in accordance with the disclosed architecture.

FIG. 4 illustrates a perspective view of the handheld mask assembly of the present invention illustrating an exterior surface of a face mask component of the handheld mask assembly in accordance with the disclosed architecture.

FIG. 5 illustrates a perspective view of the handheld mask assembly of the present invention illustrating an interior surface of the face mask component of the handheld mask assembly in accordance with the disclosed architecture.

FIG. 6 illustrates a perspective view of the rod of the handheld mask assembly of the present invention in accordance with the disclosed architecture.

FIG. 7 illustrates a perspective view of the rod of the handheld mask assembly of the present invention comprising a threaded connecting element in accordance with the disclosed architecture.

FIG. 8 illustrates a perspective view of the rod of the handheld mask assembly of the present invention comprising a magnetic connecting element in accordance with the disclosed architecture.

FIG. 9 illustrates a perspective view of the rod of the handheld mask assembly of the present invention comprising a plurality of telescoping sections in accordance with the disclosed architecture.

FIG. 10 illustrates a perspective view of one embodiment of a handheld mask assembly of the present invention comprising a strap in accordance with the disclosed architecture.

FIG. 11 illustrates a perspective view of the strap of the handheld mask assembly of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a modified face mask featuring a dowel or rod attached to the mask allowing users to hold the mask in front of their nose and mouth. The invention eliminates the need to secure a mask around the head or ears with a strap as the only means to use the mask. Users can easily comply with rules and regulations during seasonal outbreaks, the cold and flu season, a pandemic or other health crisis. The mask is configured to reduce facial blemishes and ear irritation caused by the rubbing of the mask and band against sensitive skin regions. Users can customize and personalize the masks with different logos, colors, and designs.

The rod or dowel attaches to the mask to support the mask in an upright position when held. This allows the user to position the mask over the nose and mouth for protection against airborne pathogens. The rod can be telescopic and foldable for additional adjustments and convenience. The attachment can be located on one side of the mask and can be easily slid on and off the mask. Users can apply the mask to the face and comply with regulations regarding personal protective equipment during a pandemic. The mask is intended to offer comfort when wearing a face mask. The mask can be decorated and designed in various colors and may feature any number of logos on the front to customize the look. The exact size, measurement, construction, and design specifications may vary upon further development and manufacturing.

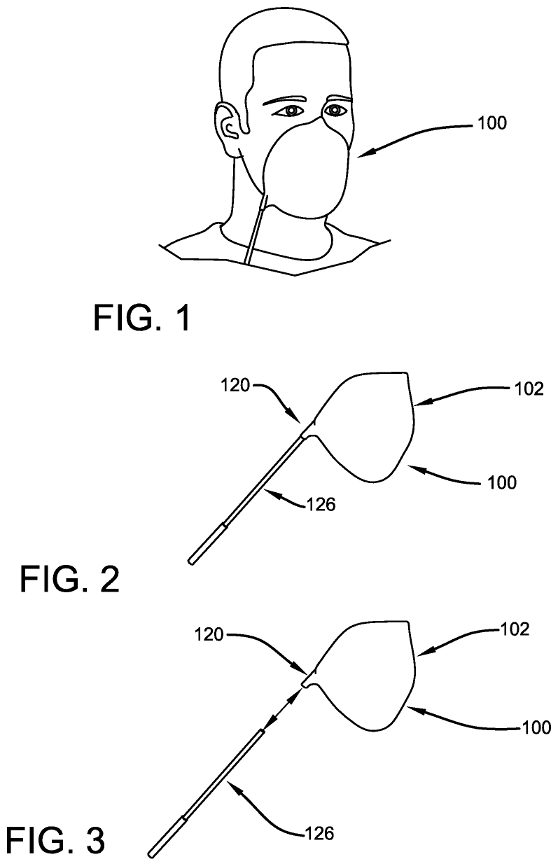

Referring initially to the drawings, FIG. 1 illustrates a handheld mask assembly 100 protecting a user's respiratory system. The handheld mask assembly 100 is configured to allow the user the flexibility to cover their nose and mouth as needed but remove the covering quickly and easily when no longer needed. As illustrated in FIGS. 2 and 3, the handheld mask assembly 100 comprises a face mask component 102, an attachment component 120, and a rod 126. The rod 126 is removably attachable to the face mask component 102 via the attachment component 120.

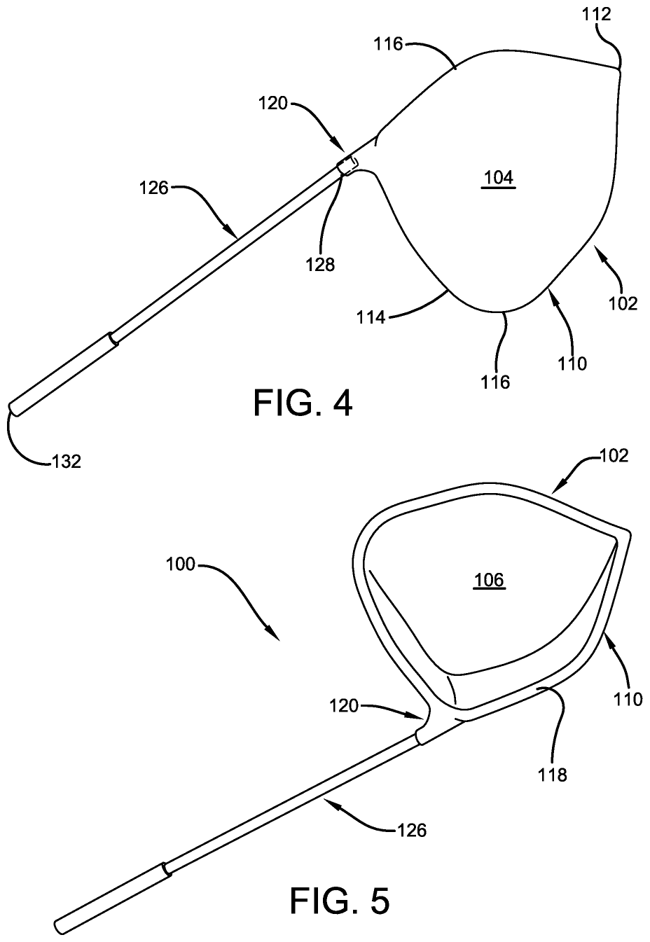

As illustrated in FIGS. 4 and 5, the face mask component 102 may be rigidly constructed or may be moldable and is shaped to cover a user's nose and mouth. The face mask component 102 is typically manufactured from fabric, cloth, filtering materials, spun-bond polypropylene, cellulose, polyester, and the like. The face mask component 102 comprises a perimeter 110, an apex 112, a base 114, and a pair of sides 116. The apex 112 is configured to encapsulate the nose and the base 114 is configured to fit the user's chin.

An interior surface 106 of the face mask component 102 faces inward toward the user's face and an exterior surface 104 faces outward. The exterior surface 104 may be customized with different logos, colors, and designs, or may be sprayed with an antimicrobial agent for additional protection. The face mask component 102 may further comprise a cushion element 108. The cushion element 108 may be a gasket or flexible pad that is positioned around and surrounds the perimeter 110 and is attached or adhered to the interior surface 106 of the face mask component 102. The cushion element 108 is advantageous as it allows for a better and adjustable fit of the face mask component 102 against a variety of differently shaped faces. Even without the cushion element 108, the face mask component 102 is configured to adjustably conform to the user's face.

As illustrated in FIGS. 7 and 8, the attachment component 120 is connected to the face mask component 102. The attachment component 120 is typically rigidly constructed and may be molded into, adhered, mechanically attached, or otherwise integrated into a lower corner of the face mask component 102 close to an intersection between one of the pair of sides 116 and the base 114. Alternatively, the attachment component 120 may be connected anywhere else along the perimeter 110 of the face mask component 102, such as along one of the pair of sides 116 or integrated into the base 114. The attachment component 120 may be plastic, wood, metal, or paper that is permanently attached, removable, telescoping, or collapsible.

The attachment component 120 comprises a receiving element 122. The receiving element 122 may be a cylindrical or geometrically shaped hole for receiving and frictionally engaging an end of the rod 126 when inserted. Alternatively, the receiving element 122 may be a threaded hole for accepting the rod 126 with a threaded end. The attachment component 120 may further comprise a rod attachment element 124. The rod attachment element 124 may be a metallic or magnetic member positioned within the receiving element 122.

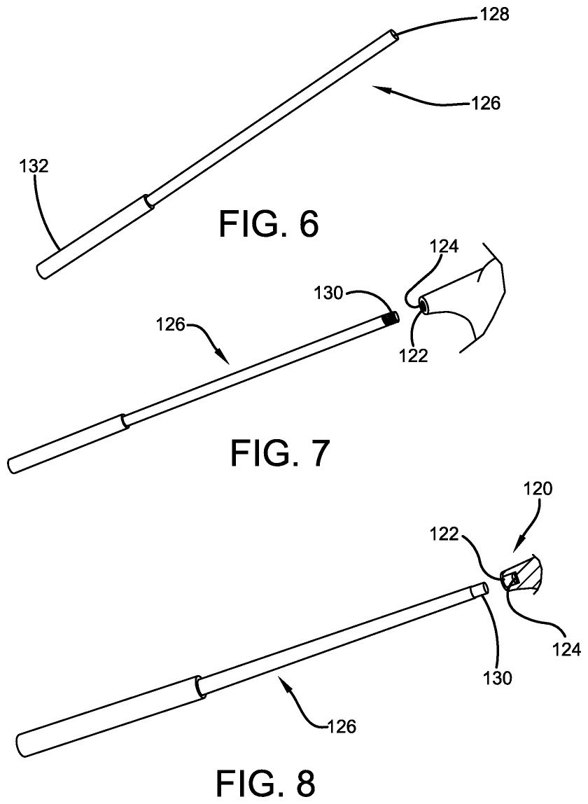

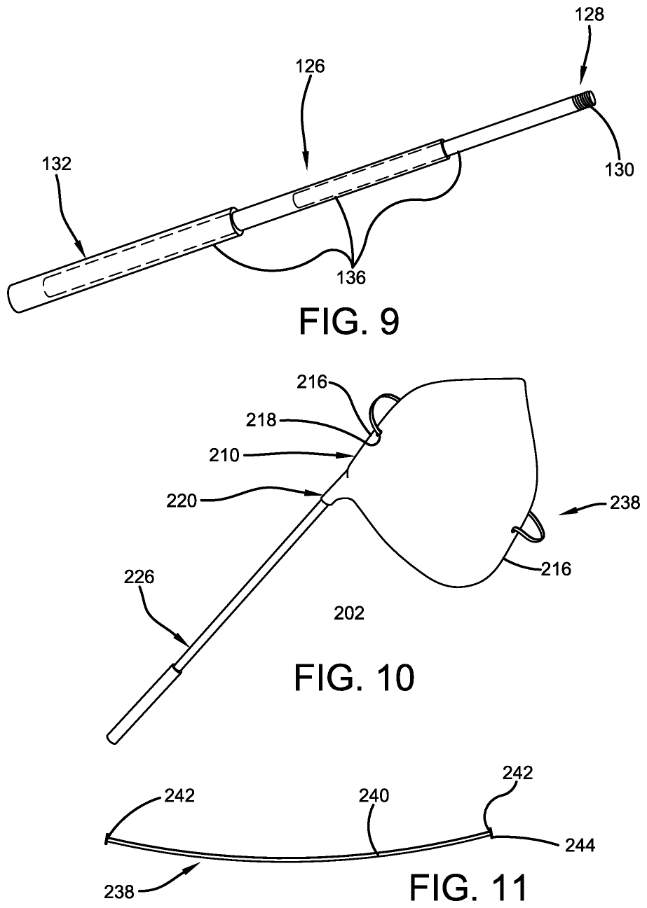

As illustrated in FIGS. 6-9, the rod 126 is generally tubular and flexible in configuration and comprises an attachment component end 128 and a distal end 132. The rod 126 may further comprise a handle 134. The handle 134 may encapsulate the distal end 132 and extend up the rod 126. The attachment component end 128 comprises a connecting element 130. The connecting element 130 is configured to engage the receiving element 122 of the attachment component 120 and removably attaching the rod 126 to the face mask component 102.

The connecting element 130 is insertable into and may engage the receiving element 122 via friction. Alternatively, the connecting element 130 may be a male threaded connector for screwing into the receiving element 122. Alternatively, the connecting element 130 may be a magnet or metal member adapted to engage the rod attachment element 124 of the receiving element 122 magnetically. The rod 126 may further comprise a plurality of telescoping sections 136 for allowing the rod 126 to adjust in length for use or to have a reduced profile when not in use. The rod 126 and handle 134 may be ergonomically shaped for comfort.

In an additional embodiment as illustrated in FIGS. 10 and 11, a handheld mask assembly 200 comprises a face mask component 202, an attachment component 220, a rod 226, and a strap 238. The rod 226 is removably attachable to the face mask component 202 via the attachment component 220. The face mask component 202 may be rigidly constructed or moldable and is shaped to cover a user's nose and mouth. The face mask component 202 is similar in configuration to the face mask component 102 and may further comprise a pair of strap holes 218. The pair of strap holes 218 penetrate the face mask component 202 along the respective pair of sides adjacent to a perimeter 210 of the face mask component 202.

The attachment component 220 is connected to the face mask component 202. The attachment component 220 is typically rigidly constructed and may be molded into, adhered, mechanically attached, permanently molded, snapped into, magnetically attached, or otherwise integrated into a lower corner of the face mask component 202 close to an intersection between one of a pair of sides and a base. Alternatively, the attachment component 220 may be connected anywhere else along the perimeter 210 of the face mask component 202, such as along one of the pair of sides or integrated into the base.

The attachment component 220 comprises a receiving element (similar to 122). The receiving element may be a cylindrical hole for receiving and frictionally engaging an end of the rod 226 when inserted. Alternatively, the receiving element may be a threaded hole for accepting the rod 226 with a threaded end. The attachment component 220 may further comprise a rod attachment element (similar to 124). The rod attachment element may be a metallic or magnetic member positioned within the receiving element.

The rod 226 is generally tubular and flexible in configuration and comprises an attachment component end (similar to 128) and a distal end (similar to 132). The rod 226 may further comprise a handle (similar to 134). The handle may encapsulate the distal end and extend up the rod 226. The attachment component end comprises a connecting element (similar to 130). The connecting element is configured to engage the receiving element of the attachment component 220 and removably attaching the rod 226 to the face mask component 202.

The connecting element is insertable into and may engage the receiving element via friction. Alternatively, the connecting element may be a male threaded connector for screwing into the receiving element. Alternatively, the connecting element may be a magnet or metal member adapted to engage the rod attachment element of the receiving element magnetically. The rod 226 may further comprise a plurality of telescoping sections (similar to 136) for allowing the rod 226 to adjust in length for use or to have a reduced profile when not in use.

The strap 238 is removably attachable to the face mask component 202. The strap 238 is a band of typically elastic or rubber material that can expand and contract to fit around the user's head to hold the face mask component 202 securely against the user's face. The strap 238 comprises a band 240 terminating in a pair of ends 242. A pair of flexible connecting elements 244 extend from each of the pair of ends 242. The flexible connecting elements 244 may each be a flexing T-connector or other similar flexible connector that can be inserted into and removed from a hole. The pair of flexible connecting elements 244 are each insertable into one of the pair of strap holes 218 of the face mask component 202 to attach the strap 238 to the face mask component 202. The strap 238 is insertable into the strap holes 218 for applications where the face mask component 202 may be needed to be in place for an extended period of time. The rod 226 is removable from the attachment component 220 when the strap 238 is in use. The strap 238 is removable when no longer needed and the rod 226 may be reinserted into the attachment component 220.

It is contemplated that the handheld mask assemblies 100 and 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld mask assembly comprising:
a face mask component;
an attachment component connected to the face mask component; and
a rod; and
wherein the rod is removably attachable to the face mask component via the attachment component.

2. The handheld mask assembly of claim 1, wherein the face mask component comprises a cushion element positioned around a perimeter of the face mask component.

3. The handheld mask assembly of claim 1, wherein the face mask component is rigid.

4. The handheld mask assembly of claim 1, wherein the face mask component adjustably conforms to a user's face.

5. The handheld mask assembly of claim 1, wherein the attachment element comprises a receiving element for receiving an end of the rod.

6. The handheld mask assembly of claim 1, wherein the attachment component is integrated into a base of the facemask component.

7. The handheld mask assembly of claim 1, wherein the rod is flexible.

8. The handheld mask assembly of claim 1, wherein the rod comprises a handle.

9. The handheld mask assembly of claim 1, wherein the rod is telescoping.

10. A handheld mask assembly comprising:
a face mask component;
an attachment component connected to the face mask component, the attachment element comprising a receiving element; and
a rod comprising a connecting element for engaging the receiving element of the attachment component and removably attaching the rod to the face mask component.

11. The handheld mask assembly of claim 10, wherein the receiving element engages the connecting element via friction.

12. The handheld mask assembly of claim 10, wherein the receiving element engages the connecting element magnetically.

13. The handheld mask assembly of claim 10, wherein the receiving element is threaded.

14. The handheld mask assembly of claim 10, wherein the attachment component further comprises a rod attachment element.

15. The handheld mask assembly of claim 10, wherein the connecting element is a male-threaded connector.

16. The handheld mask assembly of claim 10, wherein the connecting element is a magnet.

17. The handheld mask assembly of claim 10, wherein the face mask component comprises a cushion element positioned around a perimeter of an interior surface of the face mask component.

18. A handheld mask assembly comprising:
a face mask component;
an attachment component connected to the face mask component, the attachment element comprising a receiving element; and
a rod comprising a connecting element for engaging the receiving element of the attachment component and removably attaching the rod to the face mask component; and
a strap removably attachable to the face mask component.

19. The handheld mask assembly of claim 18, wherein the strap comprises a pair of flexible connecting elements for attaching the strap to the face mask component.

20. The handheld mask assembly of claim 19, wherein the face mask component comprises a pair of holes for accepting pair of flexible connecting elements.
